(19) United States
(12) Patent Application Publication
(10) Pub. No.: US 2019/0245897 A1
(43) Pub. Date: Aug. 8, 2019

(54) Shared Communication Channel And Private Augmented Reality Video System

(71) Applicant: Revealio, Inc., Pleasant Hill, CA (US)

(72) Inventor: Michelle Calloway, Walnut Creek, CA (US)

(73) Assignee: Revealio, Inc., Pleasant Hill, CA (US)

(21) Appl. No.: 15/872,338

(22) Filed: Jan. 16, 2018

Related U.S. Application Data
(60) Provisional application No. 62/447,540, filed on Jan. 18, 2017.

(51) Int. Cl. H04L 29/06; H04L 29/08

(52) U.S. Cl. CPC H04L 65/1076; H04L 67/1057; H04L 67/1046

(57) ABSTRACT

A computerized augmented reality platform for a person to send physical invitations to a plurality of recipients and then have these recipients view private augmented reality videos superimposed on these physical invitations, wherein the recipient is optionally pre-authorized by the sender to view the private video on the basis of the recipient's smart device ID, followed optionally by the recipients sharing digital media with one another over a shared communication channel.

### RELATED APPLICATION

The present application claims priority to U.S. Provisional Patent Application, Ser. No. 62/447,540, of same title, filed Jan. 18, 2017, the entire disclosure of which is incorporated herein by reference in its entirety for all purposes.

### TECHNICAL FIELD

The present invention relates to augmented and virtual reality displays and to systems for presenting such displays to recipients of physical invitations such as greeting cards, business cards and business brochures.

### BACKGROUND OF THE INVENTION

For years, people have been sending one another greeting cards, including holiday cards and invitations to events such as weddings, birthdays, anniversary parties, family and corporate celebrations, etc. Oftentimes, these invitation cards have photos of the sender or senders, typically the sender's family or the sender's corporate employees. Recipients of these cards really treasure them. Often, these cards provide a strong emotional link from the recipient back to the sender.

Unfortunately, traditional photo greeting cards are static. The recipient typically opens an envelope, removes the card and then stares at a photo of the sender (such as a family photo on a typical Christmas or holiday card). Recipients of these greeting cards long for a deeper emotional connection to the sender. A photograph can only convey a limited amount of emotional contact. Oftentimes, the recipient receives the card and then picks up their phone and calls, texts or messages the sender to either reply to the invitation, or to simply to communicate with the sender for a deeper emotional connection.

The same problem is true with business cards which too often have a very standard format (i.e.: look and feel), and are actually rather impersonal as most don't even carry a static picture of the person. Therefore, business cards are often simply tossed into a drawer after a meeting. When people later wish to recall the people who they have just met, they often are forced to go to LinkedIn or other social networking site to view a photo of the person who's business card they are actually looking at.

What would instead be desirable is a system where the recipient is able to both hear and see the sender and the message they are delivering together with the greeting card invitation (or the business card introduction). The present invention provides such a system.

It would also be desirable for the recipients of greeting cards to be able to communicate with one another. For example, when a person receives a wedding invitation card, they may also want to share their photos and impressions of the event at a later time with the other people who were also invited to the wedding. The same is true in the context of business cards as it may be desirable to set up business communication channels between different people (or groups of people) conducting business. Again, the present invention provides such a system.

It would also be desirable to ensure that such video greetings that are sent from one person to another remain private. People sending videos of themselves to people they care deeply about (or want to do business with) want to ensure that these videos remain private and cannot simply be viewed by anyone else other than the desired recipient. (This is especially important when the video is sent in conjunction with a physical invitation to view the video, as it is important that the physical invitation card does not land in the wrong hands). The present invention provides such a secure video transfer system.

### SUMMARY OF THE INVENTION

The present invention provides a computerized augmented reality platform enabling a person to send physical invitations to a plurality of recipients and have these recipients:
(a) view augmented reality videos superimposed on these physical invitations, and then
(b) share digital media with one another over a shared communication channel.

In one aspect, the present invention provides a method of operating a shared augmented reality communication channel on an augmented reality platform, comprising: (a) a first user creating an augmented reality communication channel on the augmented reality platform; (b) the first user creating a video and linking the video to the augmented reality communication channel on the augmented reality platform; (c) the first user designing a physical invitation with visual indicia thereon and linking the visual indicia on the physical invitation to the augmented reality communication channel; (d) the first user inviting one or more other users to join the augmented reality communication channel by sending the physical invitation to each of the other users; (e) the other users each scanning the visual indicia on the physical invitation with a smart device such that: (i) a display on their smart device displays the video in an augmented reality presentation superimposed on the physical invitation, and (ii) access to the augmented reality communication channel is granted to the other users; followed by (f) the other users and the first user each sharing digital media with one another through the augmented reality communication channel.

In one example of the present invention, the computer platform operates such that a couple can prepare their wedding invitation card and then have the system mail out the invitation cards. Using different approaches, the cards can either be mailed as a batch to the sender(s) for the sender(s) to later individually mail them out to their guests. Alternatively, the cards could be individually mailed out directly to the sender(s) guests by the present system. It is to be understood that the present system encompasses all mailing and delivery options. When each of the guests receive their cards in the mail, they can each scan the card with their own smart devices such that when viewed through their phone, a photo of the wedding couple on the card comes alive and the invited guest sees a video of the couple inviting them to the wedding. Preferably, the video of the couple is superimposed on the card itself in an augmented reality format. As such, when the guest moves the card in their hand, the video invitation of the couple will track the movement of the physical card. Simply put, the invited guest sees a living picture in which the people in the photo talk and move when viewed through the phone screen. As the physical card is rotated or tilted back and forth, so too is the augmented reality video that appears superimposed on the card.

In accordance with the invention, the sender(s) of the greeting card both designs the appearance of the physical card itself (including the taking of the photo of the couple and the placement of the photo right onto the printed card). The couple also records the video they want to be played when the invited guest recipients receive the greeting card in the mail. It is to be understood that although the above example deals with wedding invitations, the present invention is not so limited. As will be explained, the physical invitation may be any type of card or not be a card at all. Instead, any form of printed material can be used as the invitation onto which the augmented reality video is displayed, and in any situation. For example, the card may be a business card or brochure that comes alive and speaks and tells a story then viewed through the present system. Further examples will be given below.

In further aspects of the invention, the present system also grants access to an “augmented reality communication channel” to the recipients of the card. Specifically, once the recipient has scanned the greeting (or business or other) card to view the augmented reality video, the system will then grant them access to a predefined communication channel through which various card recipients can communicate with other card recipients. For example, after a wedding to which the guests are invited with a wedding invitation card, the guests can then share and upload their own photos and videos of the wedding, and optionally text or message one another. Similarly, after a business introduction, a virtual meeting or discussion or brainstorm area can be created where recipients of the business cards can upload their own photos and videos, and optionally text or message one another.

The amount of access that each guest gets to the shared communication channel can be pre-determined by the engaged couple initially designing and sending wedding invitation greeting cards. For example, the couple may decide that their guests (i.e.: card recipients) can only upload and view photos. Or they may also grant the recipients the right to download each other's photos and videos as well. The couple may or may not wish to give their guests the right to edit photos, etc. However, as will be shown, different users can be given different access rights to the communication channel network. In optional embodiments, some users may even be given the option of granting access rights (or setting the access rights) of other users.

In alternate aspects, the present invention provides an augmented reality communication platform that enables a person to send a physical invitation to a recipient and have the recipient view a private augmented reality video superimposed on the physical invitation. As will be shown, an important advantage of the present invention is that only the desired recipient of the physical invitation can access and view the video. This offers the advantage of security and privacy for the sender. Simply put, an accidental or undesired recipient that comes into possession of the same physical invitation cannot access and view the sender's private video.

In one aspect, the present system provides a method of operating an augmented reality computer platform to send a private augmented reality video to a recipient, comprising: (a) a first user creating a private video; (b) the first user designing a physical invitation with visual indicia thereon; (c) the augmented reality computer platform associating the visual indicia on the physical invitation with the private video; (d) the first user sending the physical invitation to a second user; (e) the second user scanning the visual indicia on the physical invitation with a smart device; (f) the smart device sending a smart device ID to an authorization system in the augmented reality computer platform; and then (g) the authorization system sending the private video to the smart device of the second user, thereby permitting the second user to view the private video in an augmented reality presentation superimposed on the physical invitation.

In another example of the present system, a student that has recently moved away from home to college operates the augmented reality communication platform to create an augmented reality video greeting card and then have the present system mail the greeting card to her/his parents. When the parents receive the card in the mail, they scan the card with their smartphone such that when viewed through their phone, the photo of the student comes alive and talks briefly about his/her experience away from home. Preferably, the parents simply scan the invitation card and access the private augmented reality video through an app downloaded onto their smart phones or similar devices.

Similar to the previous example, the video of the student is superimposed on the card itself in an augmented reality format. As such, when the parents move the card in their hands, the video of the student will track the movement of the physical card. Simply put, the parents see a living picture (superimposed on the card) in which the student talks and moves when viewed through the phone screen.

In accordance with the present invention, the student sender of the card uses the computer platform to both design the appearance of the physical card itself (including the taking of their own photo and the placement of the photo right onto the printed card). The student also records the private video they only want to be played when their parents receive the card in the mail. It is to be understood that although the above example deals with a student away from home, the present invention is not so limited. As will be explained, the physical invitation may be any type of card or not be a card at all. Instead, any form of printed material can be used as the invitation onto which the augmented reality video is displayed, and in any situation. Further examples will be given below.

In further aspects of the present invention, the private video is “secure” and can only be opened by the smartphone(s) owned by the student's parents. This is accomplished by the present augmented reality computer platform's authorization system which verifies the parents' identities by verifying the identity of the parents' smart phones or other smart devices, such as recognizing the phone numbers of either of the parents' smartphones prior to allowing their devices to play the private augmented reality video the student has recorded.

Similarly, in the wedding couple example above, the wedding couple may wish to pre-authorize only certain individuals to receive and open the invitation card on their smart devices in the first place. This can be accomplished by using the present computer platform to pre-authorize the phone numbers of the recipients that are to be allowed to open and view the augmented reality video. In such situations, different recipients may even be given different augmented reality videos to view (depending upon the identities of the recipients).

Preferably, the invited guests both scan the invitation cards and access the augmented reality communication channel through an app downloaded onto their smart phones or similar devices.

Although the present system is ideally suited to work with greeting and business cards, it is to be understood that the present invention is not so limited. For example, greeting or business cards can be substituted with other physical invitations, including but not limited to: (i) a product or service brochure, or (ii) a sign or billboard. Other examples are also possible. Therefore, it is to be understood that any physical invitation with visual indicia that can be read and recognized by the recipients' smart devices could be used.

The present system also provides an augmented reality communication platform, comprising: (a) a configuration system for users to define augmented reality communication channels; (b) a physical invitation design system for users to design physical invitations having visual indicia thereon and associate the visual indicia on the physical invitations with the defined augmented reality communication channels; (c) a video uploading system for users to upload videos and associate the uploaded videos with the defined augmented reality communication channels; and (d) a communication system for users to communicate with one another over each of the defined augmented reality communication channels. This augmented reality communication platform may optionally be resident on a server, in the cloud, or resident on one or more of the smart devices of the users, or any combination thereof.

Preferably, the augmented reality communication platform also includes an authorization system that permits: (i) users to pre-authorize the other users to join the augmented reality communication channels by pre-authorizing the smart device IDs of the other users to join the augmented reality communication channel, and (ii) receiving the smart device IDs of the other users to permit authorization for the other users to join the augmented reality communication channels.

Similarly, the present system also provides an augmented reality computer platform, comprising: (a) a physical invitation design system for a user to design a physical invitation having visual indicia thereon and associate the visual indicia on the physical invitations with a pre-defined recipient; (b) a video uploading system for the user to upload private videos and associate the uploaded private videos with the pre-defined recipient; and (c) an authorization system for: (i) receiving a smart device ID from a second user after the second user's smart device has scanned the visual indicia on the physical invitation, and (ii) permitting the second user to view the private video in an augmented reality presentation superimposed on the physical invitation. Preferably, the smart device ID corresponds to the second user's smart device phone number.

In optional embodiments of the present invention, the first user records separate private videos with different private videos being sent to different recipients. This can be accomplished by the present system recognizing different smart device IDs from the different recipients. Specifically, the sender can select one recipient's smartphone to play a first private video and a second recipient's smartphone to play a second private video. This can be done by the sender entering their different phone numbers into the platform with the different phone numbers being linked to different private videos. In this scenario, identical physical invitations can be sent to both recipients with the system then determining which private video to play based on the identities (i.e.: phone numbers) of the smartphones.

Alternatively, several different recipients may be sent the same private video (with the system first recognizing these recipients on the basis of their smart device IDs). As such, the private video can only be played on one of the intended recipients' smartphones. Specifically, if an unintended recipient tries to play the private video, it will not play since the phone number of the unintended recipient will not be recognized by the system. This feature of the invention provides security and privacy.

In further optional embodiments, different recipients of the private video(s) can even share digital media with one another over a shared augmented reality communication channel that has been pre-defined by the sender.

In further optional aspects of the present system, objects such as business cards or brochures, (or even signs or posters) can be read by Optical Character Recognition (OCR) to identify the recipients of the physical invitations. In such aspects, the names, titles and phone numbers of the business card holders can be used to link the identities of the business card holders to particular private augmented reality videos. As such, different videos can be sent to groups of people having similar titles. For example, a person receiving an invitation card can be first asked to scan their business card (prior to playing the augmented reality video). The scan may recognize the word “President” or “CEO” such that when this same person plays their augmented reality invitation card, an augmented reality video that is particularly suited to company presidents can be played. In addition, the scanned names, phone numbers and titles of different people can be added to various system databases such that these people can be grouped together in any format desired. For example, an augmented reality presentation for “West Coast Corporate Partners” can be played for those scanned business cards that have West Coast Area Codes on their phone numbers. After these business cards are scanned, the persons presenting these cards can all be optionally added to the sender's contacts.

In other aspects, Optical Character Recognition (OCR) can also be used to scan the invitation card itself to recognize words and numbers on the card that identify the card as being a “Jack and Jill's Wedding Invitation” card, etc. The advantage of this approach is that large QR Codes printed on the cards can be eliminated.

Thus, the present system can use Optical Character Recognition (OCR) either to scan (and thereby identify) the invitation card, or to use Optical Character Recognition (OCR) to first scan the recipient's business card (or Driver's License, Deed or other identifying Document), so as to first identify the recipient of the invitation card such that a unique private video can be played for that particular recipient. The advantage of this approach is that the same physical invitations can be sent to various recipients, but with different private videos being played for different recipients. In addition, the scanned phone numbers on the business cards can be used to activate the shared communication channels described herein.

In further optional aspects, the user taps on the screen of their smartphone to simultaneously initialize an image based recognition system and an Optical Character Recognition (OCR) system which together identify the invitation card. For example, the image based recognition system may recognize the card as using one of a preferred number of templates (such as a Wedding Invitation template), while the Optical Character Recognition (OCR) system reads the card which may state “Come to Eric And Anna's Wedding”. The simultaneous use of both an image recognition system and an Optical Character Recognition (OCR) system can advantageously recognize cards faster and with an additional layer of security (such that the present system does not play an incorrect augmented reality video). Furthermore, the physical act of the recipient tapping on their smartphone's screen to simultaneously commence image and optical character recognition provides an easy to use starting (initiation) point for both these systems. Specifically, the recipient's smartphone will be facing the card and ready to read the card when the smartphone's screen is tapped.

### BRIEF DESCRIPTION OF THE DRAWINGS

FIGS. 1A1 and 1A2 are detailed illustrations of participants and physical equipment operated by the participants of a shared augmented reality communication channel.

FIG. 1B is a simplified version of the physical components of FIGS. 1A1 and 1A2, showing additional participants (invitation recipients) and communication over the shared communication channel.

FIG. 2 is an illustration of an opening screen of a smartphone app embodying the present augmented reality platform, when the user is first selecting to either read an existing card or create a new card.

FIG. 3A is an illustration of the user creating a new wedding invitation card and selecting the wedding card template.

FIG. 3B is an illustration of the user adding a personal photo to the wedding invitation card.

FIG. 3C is an illustration of the user adding a personal video greeting to the wedding invitation card.

FIG. 3D is an illustration of the user adding recipients' addresses for delivery of the invitation card.

FIG. 3E is an illustration of the user sharing digital media with other users over a communication channel (by sharing text, videos or photos on the communication channel).

FIG. 4A is an illustration of a greeting card coming to life when the recipient receiving the greeting card (e.g.: the wedding invitation made by the process of FIGS. 3A to 3D) is then scanned with the recipient's smartphone.

FIG. 4B is an illustration of a business card coming to life when the recipient of the business card scans the business card with their smartphone.

FIG. 5A is an illustration of an invitation card being read by an Optical Character Recognition (OCR) scanner.

FIG. 5B is an illustration of an Optical Character Recognition (OCR) system for pre-identifying a invitation card recipient to determine which private video the invitation recipient will be viewing.

### DETAILED DESCRIPTION OF THE DRAWINGS

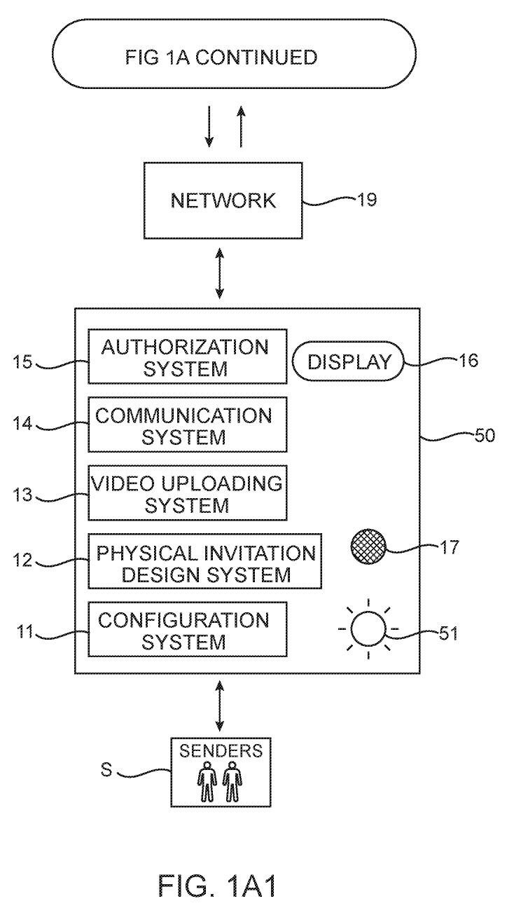

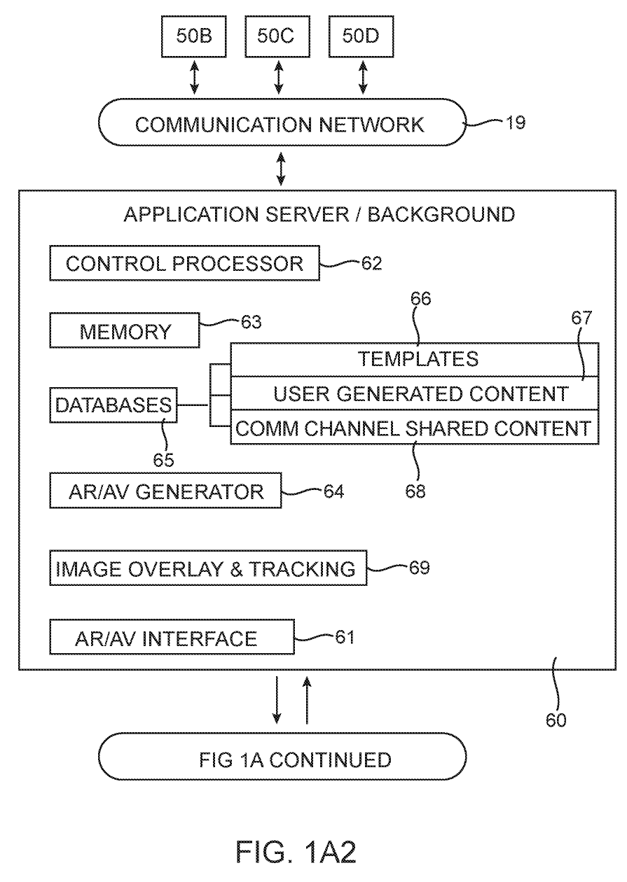

FIGS. 1A1 and 1A2 and 1B are illustrations of equipment and participants of a shared augmented reality communication channel showing an augmented reality platform 10 to communicate and exchange digital media with one another. Specifically, a sender S uses augmented reality platform 10 to send physical invitations (such as greeting or business cards 20) to a plurality of recipients R1, R2 and R3. Sender S designs cards 20 and printer 30 physically produces cards 20 for mailing to each of recipients R1, R2 and R3.

As seen in FIG. 1B, augmented reality platform 10 may comprise both software downloaded onto a local smartphone 50 and a remote backend system 60 that preferably is hosted on (and operates on) an application server(s). In one preferred embodiment, platform 10 comprises the computerized systems operating in both the local smartphone 50 and the remote backend server 60. It is to be understood, however, that augmented reality platform 10 may have operational components distributed both locally and remotely in any format. Thus, some or all of the components of systems 50 and 60 may be distributed between various devices and may be shared between these devices. As such, components described herein as operating in smartphone 50 may instead be operating in remote backend system 60, or vice versa. Moreover, components described herein as operating in smartphone 50 may instead be operating partially within smartphone 50 and remote backend system 60, or vice versa.

As seen in FIG. 1A1, augmented reality platform 10 preferably comprises software downloaded onto smartphone 50 that includes: a configuration system 11 for users to define augmented reality communication channels; a physical invitation design system 12 for users to design physical invitations having visual indicia thereon such that the visual indicia on the physical invitations are associated with the defined augmented reality communication channels; a video uploading system 13 for users to upload private and non-private videos and associate the uploaded videos with the defined augmented reality communication channels; and a communication system 14 for users to communicate with one another over each of the defined augmented reality communication channels. Optionally included as well is an authorization system 15 for: (i) senders or recipients to pre-authorize the other users to join the augmented reality communication channels by pre-authorizing the smart device IDs of the other users to join the augmented reality communication channel, and (ii) receiving the smart device IDs of the other recipients to permit authorization for the other recipients to join the augmented reality communication channels. Smartphone 50 will also have a standard display screen 16, a microphone/speaker 17 and a camera 51.

Smartphone 50 will communicate through cell phone network 19 to remote backend system 60. Backend system 60 will include an Augmented Reality/Virtual Reality interface 61 between which communication passes with the senders S. Backend system 60 is controlled by a control processor 62, and includes memory 63.

Augmented Reality/Virtual Reality Generator 64 generates the augmented reality experience that the recipients R1, R2 and R3 will see when they look at their invitation cards 20 in accordance with the present system. Augmented Reality/Virtual Reality Generator 64 generates the augmented reality experience by interfacing with the video senders S through the present platform 10. The generation of augmented reality/virtual reality experiences can be carried out by working with images stored in databases 65. Specifically, databases of templates can be stored in template database 66. These templates can be generic images organized into “holidays”, “wedding invitations”, etc. As will be explained, the user(s) can choose one of these templates (should they wish to do so), when starting to design their card. A second database is the User Generated Content database 67. This is the database where the videos generated by sender(s) S can be stored. A third database is the Communication Channel Shared Content database 68. This is the database where the photos, videos and texts that various users wish to share can be stored. (The optional use of this remote database 68 avoids all users from having to store all the shared content on their own smartphones 50). For example, after a wedding, the recipients of the wedding invitations can all store photos and videos with one another in this database. It is to be understood, however, that users may instead wish to store the shared photos and videos on their own smartphones 50 (or on any other device, as desired). System 60 preferably also includes an Image Overlay and Tracking system 69 that correlates movement of cards 20 to the laying of the videos (such that the video overlay tracks well with the physical movement of the photos on cards 20).

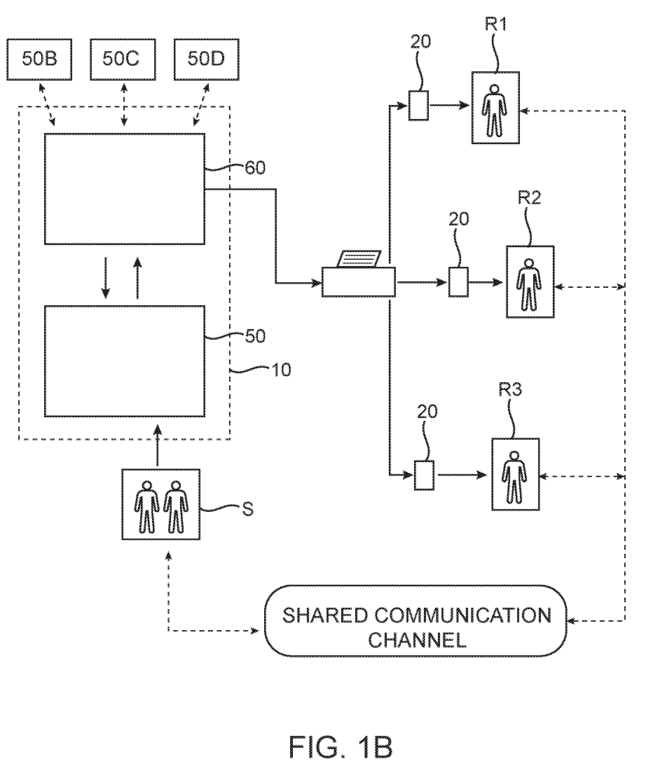

FIG. 2 shows a screenshot of an opening screen of a smartphone app embodying the present augmented reality platform, when the user is first selecting to read an existing card (at button 101) or to create a new card (at button 102). Conveniently, the screen of the app may illustrate its operation, by providing a picture of a smartphone 50 viewing a card 20 being scanned by the app (see photos above buttons 101 and 102). In the illustrated example, the photo on the card shows a baby sleeping, whereas the video shows the baby awake with her father, so as to give the impression of movement).

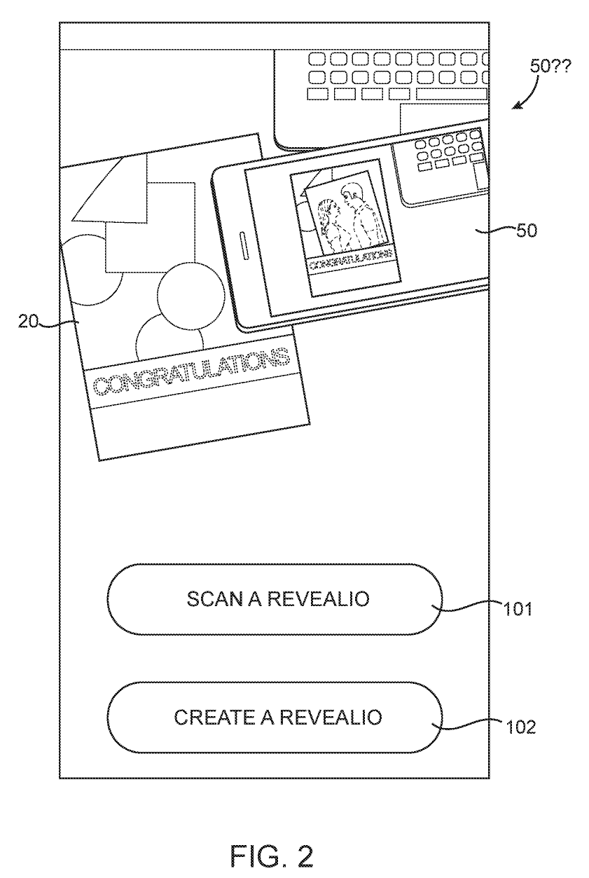

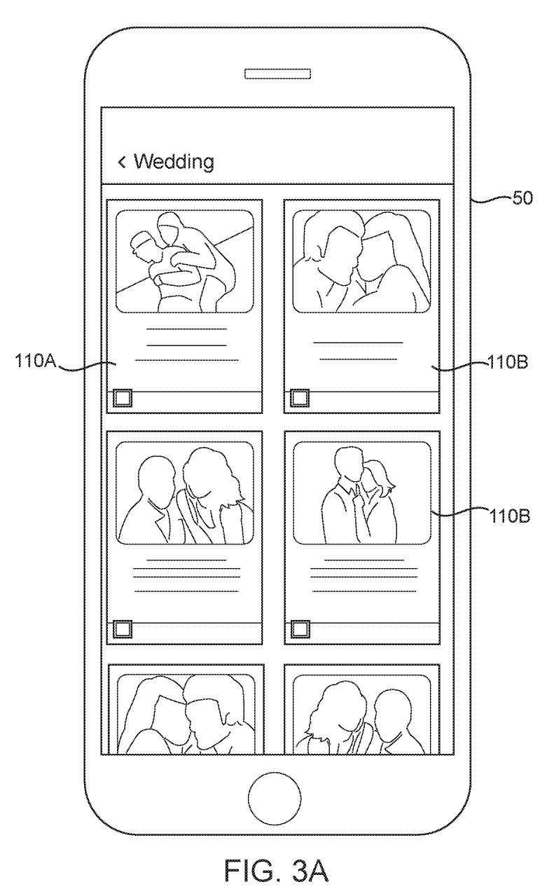

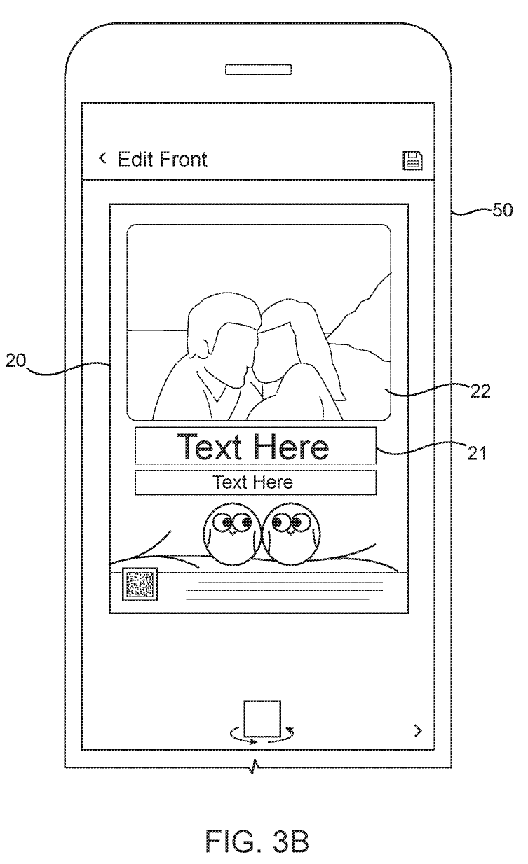

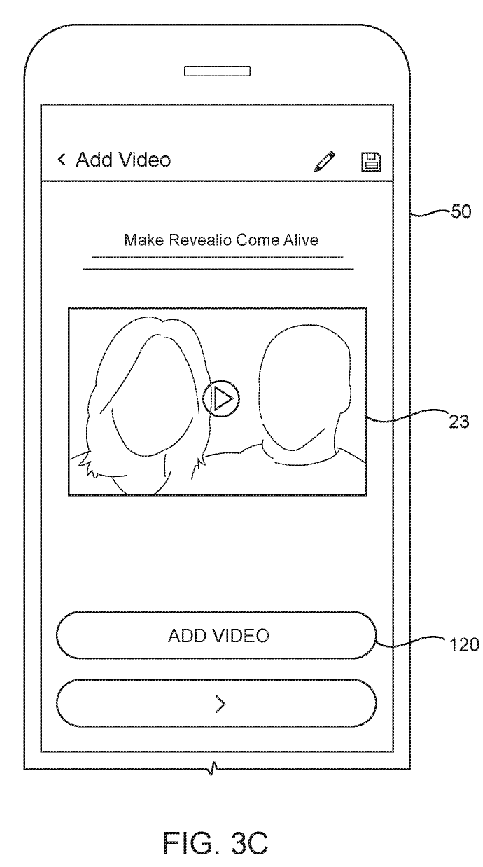

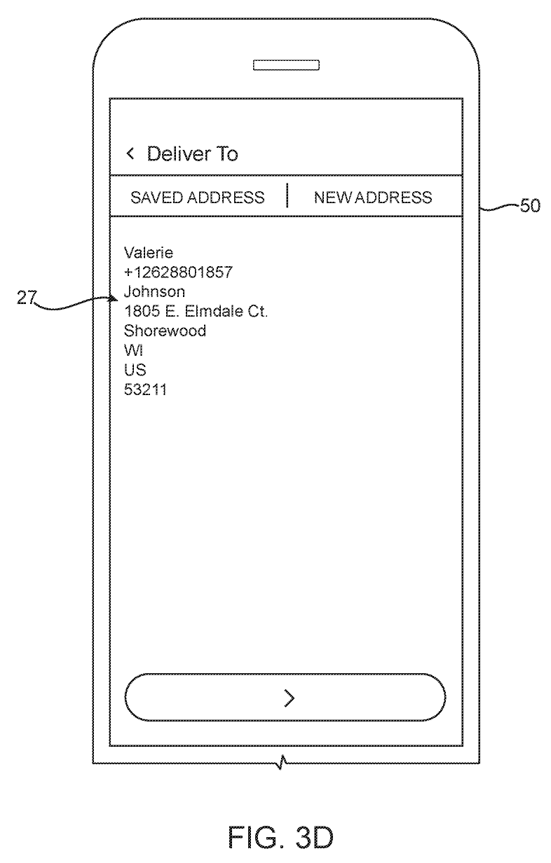

The steps of creating an exemplary greeting card using the present system will now be outlined. First, FIG. 3A shows an illustration what senders S see when interacting with the augmented reality platform 10 to design a greeting card 20 and upload a video for use with greeting card 20. Specifically, in the present wedding invitation example, senders S are the engaged couple who are designing their wedding invitation greeting cards 20. Senders S can use one of their smartphones 50 (or any other suitable smart device such as an iPad, tablet, etc.) in conjunction with the present augmented reality platform 10 as follows. Preferably, senders S design their greeting card 20s through a computer app embodying the present system that has been previously downloaded onto the smartphone 50 that they will use. (Either one of the two senders' smartphones can be used). In one embodiment, this downloaded phone app communicates with a remote system 60 (such that many different senders 50B, 50C, etc. can simultaneously design their own greeting cards using the same centralized augmented reality platform 10 communicating through network 19). As such, augmented reality platform 10 may be hosted by a server (or be hosted in the cloud) to which all separate senders S communicate. In other embodiments, augmented reality platform 10 is simply distributed in the various computer apps downloaded onto each of the various senders' smart devices 50. Thus, the present augmented reality platform 10 may be centrally located, or it can be distributed at different physical locations, all keeping within the scope of the present invention.

In the other example described above, the sender can instead be a student away at university interacting with the augmented reality platform 10 to design one or more greeting cards 20 and upload private video(s) for use with greeting cards 20. Specifically, this student sender can be designing several different greeting cards 20 to send to friends and relatives and talk about life away from home.

In yet another example, the sender can be a business person designing a marketing program to be presented to other businesspeople on introduction cards 20. As can be appreciated, the possibilities of who is the sender(s) and who are the recipients is endless. It is to be understood that the present system encompasses all of these options and variations.

To create their personalized cards 20, senders S interact with augmented reality platform 10, as follows. Returning to FIG. 3A, the wedding couple may first select one of many wedding templates (110A, 110B, 110C, etc.) for the format of their wedding invitation card. Next, in FIG. 3B, the couple adds text 21 and a photo 22 of themselves. Additionally, card 20 may be printed with a QR Code (not shown) that can be used by augmented reality platform 10 to link the pre-recorded video to the particular greeting card 20. It is to be understood that the use of a QR Code is optional and that other image recognition systems can be used instead (so as not to visually detract from the photo 21 itself). The final image of card 20 (which will later be mailed to the various recipients) is displayed on the screen of sender's smartphone 50. In addition, senders S create an augmented reality communication channel on the augmented reality platform 10. Specifically, they define the communication channel in the system by preferably giving it a name (e.g.: “Eric And Anna's Wedding Channel”) and defining its parameters.

Next, as seen in FIG. 3C, the couple (senders S) creating their own personal video (e.g.: they record a video of them saying “You're all invited to Eric And Anna's wedding. We can't wait to see you there”). Next, using their smartphone 50 with augmented reality platform 10, they then link this video to their previously created communication channel.

As stated above, the senders S design the physical appearance of the physical invitation (greeting or invitation card 20). For example, they can select background or template images 110A, 110B, 110C, etc. from database 66, or they can optionally use their own background images instead. They can also optionally select the placement of the photo 22 on card 20, as shown. The borders and background surrounding photo 22 can optionally be selected from among a library of image templates. For example, senders S may browse through a selection of potential images that are first categorized into “birthday templates”, “anniversary templates”, “miss you” templates, etc. that can be stored in platform 10. As such, the present system assists the senders in selecting the appearance of their card 20, while still allowing them to select their own photo 22 to fully personalize their own card.

Similarly, in the above example of a college student newly moved away from home, (s)he can use the present system to create a private video (e.g.: record a video of saying “College is great, but I miss you all so much!”). When the card design is done, computerized platform 10 will then link the physical invitation (i.e.: card 20) to the private augmented reality video that college-student-sender S previously created. The steps of designing the physical invitation, recording the video and linking both of these to the communication channel can be done in any order, all in keeping within the scope of the present invention.

When the card design is done, computer platform 10 will link the physical invitation (i.e.: card 20) to the augmented reality communication channel that sender(s) S previously created. Note: the steps of designing the physical invitation, recording the video and linking both of these to the communication channel can be done in any order, all in keeping with the scope of the present invention.

Returning to FIG. 3C, the couple adds their personal video 23 to the card. This can optionally be done either by selecting to use the smartphone's camera by selecting button 120, or one of the photos already stored in the smartphone by selecting a photo gallery. The senders have the option to re-play and re-record the video 23 multiple times, until it is to their final liking.

Next, in FIG. 3D, the sender adds recipient's addresses 27 for delivery of the invitation card.

Next, in FIG. 3E, the sender and recipients will be able to share digital media to the open shared communication channel by adding comments as text by selecting button 150, uploading photos by selecting button 151, or by adding videos by selecting button 152.

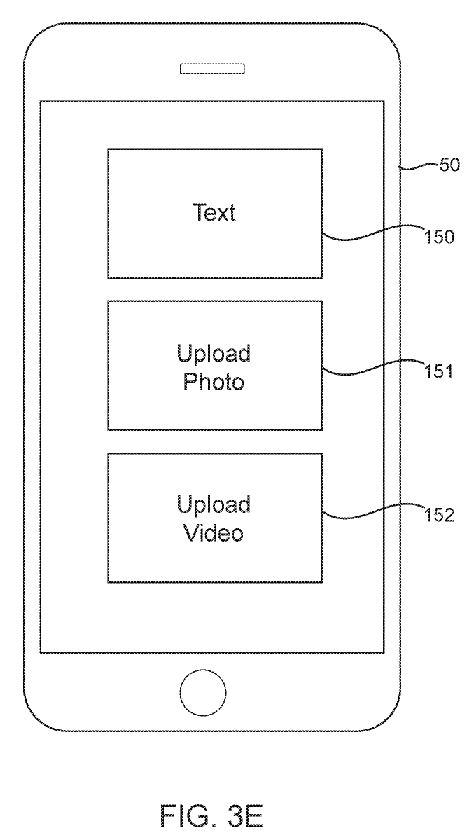

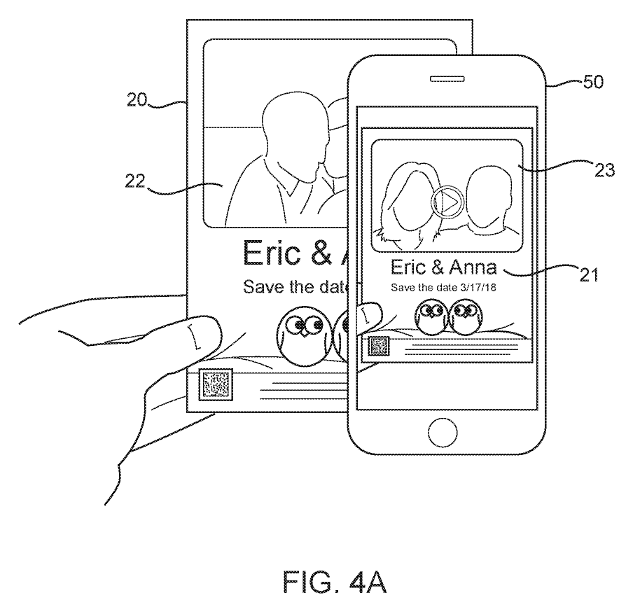

FIG. 4A illustrates the final greeting card 20 corning to life when the recipient receiving the greeting card is then scanned with the recipient's smartphone. Specifically, the recipient simply holds their smartphone over the face of the card 20 that they just received in the mail. The recipient simply points the camera of smartphone 50 towards the card and starts the app (that has been pre-downloaded onto the smartphone). At this time, the couple in the video 23 will come to life, their video will be played superimposed on the card where they will invite the recipient to their upcoming wedding. In various aspects, the video 23 can be superimposed on either the photo 22 or over the entire surface of card 20.

FIG. 4B illustrates an alternate application in which the recipient has received a business card 20, and the present system then projects the pre-recorded video onto the business card. Thus, the recipient simply looks into their phone screen and sees and hears the private (or non-private) video associated with the business card be the card's creator.

In both cards 20 in FIGS. 4A and 4B, the senders design their cards 20, and record the accompanying video. The greeting cards of FIG. 4A can be printed by printer 30 and mailed (or otherwise delivered) to each of recipients R1, R2 and R3. As will be explained, the mailing of cards 20 to each of the recipients R1, R2 and R3 is used as an invitation to join the previously created “Eric And Anna's Wedding Channel”. Similarly, the college student sender may define the communication channel in the system by preferably giving it a name (e.g.: “My First Year In College”) and defining its parameters. In the case of business cards illustrated in FIG. 4B, the cards' creator will likely have the cards printed in bulk and then hand deliver individual cards to people they personally meet. It is to be understood, however, that business cards can also be mailed to recipients as part of a sales or advertising promotion.

As can be seen, the various greeting cards 20 will have visual indicia thereon. Such visual indicia can optionally be in the form of an optional QR Code, but the present invention is not so limited. Any suitable visual indicia is possible in accordance with the present system. All that is required is that platform 10 recognizes the identity of the card 20 when it is scanned by the smart device 50 of each recipient R. As such, other image recognition systems (e.g.: non-QR Code) suitable visual indicia can include the location where images are placed on the card when it is designed (such as the exact placement or arrangement of stock “wedding” images or border trim elements), text that is printed on the card, etc. The present system thereby encompasses all methods of visually identifying the card through its visual indicia.

In various privacy aspects of the present system, the sender interacts with augmented reality platform 10 to create a video (e.g.: college-student sender can record a private video saying “School is great but I miss you”). Next, using their smartphone 50 with augmented reality platform 10, they then link this video to a list of recipient phone IDs (e.g.: cell phone numbers). When the card design is done, computer platform 10 will link the physical invitation (i.e.: card 20) to the private video that senders S previously created. Note: the steps of designing the physical invitation, recording the private video and linking both of these to the communication channel can be done in any order, all in keeping with the scope of the present invention.

As previously explained above, each of the recipients R use their smart phones (or other smart devices) to scan the card 20 that they have just received in the mail. Specifically, the app downloaded onto their smartphone 50 will then recognize the visual indicia on the physical invitation card 20 when seen by the smartphone's camera. For example, the app can be programmed to recognize an optional QR Code on card 20. As explained above, however, any recognizable visual indicia can be used instead.

In various aspects, when the smartphone's camera of the recipient's smartphone 50 is pointed at card 20, the card is scanned and is identified by its visual indicia. Next, the display on smart phone 50 displays the video in an augmented reality presentation superimposed on card 20. Stated another way, the recipient R will see the video that senders S have pre-recorded for this card. In the video of FIG. 4A (which is displayed on the screen of phone 50, and heard through the speaker of phone 50), the engaged couple will speak out and invite the recipient to their wedding. Basically, the recipient will see the photo on the card “come to life” (i.e.: see the photo move and hear the people in the photo speak).

Preferably, authorization system 15 will verify the recipients' identities by verifying the identity of the recipients' smart phones or other smart devices. For example, authorization system 15 may be pre-programmed by the sender S to recognize the phone numbers of either of the parents' smartphones prior to allowing their devices to play the private augmented reality video the student has recorded. As such, authorization system 15 will preferably first receive the smart device ID from the parent's cell phone that has scanned the visual indicia on the physical invitation, and then permit the recipient to view the private video in an augmented reality presentation superimposed on the physical invitation. Preferably, the smart device ID corresponds to one of the recipients' smart device phone number. (Thus, the sender can pre-input both different pre-identified cell phone numbers into the authorization system such that if either cellphone is used, it will be authorized to play the private video). Thus, the video can be private such that it can only be seen by family, friends, business colleagues, etc., as desired.

Next, the display on smart phone 50 displays the private video in an augmented reality presentation superimposed on card 20. Stated another way, the recipient R (e,g.: the wedding guest) will see the video that the sender S has pre-recorded for this card. In the video (which is displayed on the screen of phone 50, and heard through the speaker of phone 50), the sender(s) will speak out and tell their parents that they miss them, or invite them to their wedding. Basically, the recipient will see the photo on the card “come to life” with people in the photo moving and speaking.

When recipient R1 scans the card 20, platform 10 will also grant him/her access to the augmented reality communication channel that was pre-set up by senders S when the greeting cards 20 were first designed. In the example of FIG. 4A, other recipients R2 and R3 will each receive their own greeting card 20 wedding invitation in the mail. After they all scan their own cards with their own smartphones, and each view the wedding invitation video (of FIG. 2A), then augmented reality platform 10 will add them all to the pre-defined augmented reality communication channel. At this time, they can each share digital media (photos, videos, texts, messages, etc.) with one another through platform 10. For example, after Eric and Anna's wedding, the wedding guest recipients R1, R2 and R3 could share photos of the event with one another. These photos (and other shared digital media) can optionally be stored at a central server, or in the Cloud or on the smartphones 50 of the recipients, or any combination of the above. Stated another way, components 50 and 60 may share functionality and are part of the same overall platform 10. The communication channel itself can operate over a standard cell phone or wi-fi network 19.

Preferably, the access rights of each of recipients R1, R2 and R3 can all be pre-set by senders S when the augmented reality communication channel is first set up. For example, senders S may give recipients R1, R2 and R3 equal rights to upload and view each other's photos. Optionally, some or all of recipients R1, R2 and R3 may be given rights to download each other's photos. However, different rights may optionally be given to different R1, R2 and R3. For example, in further optional embodiments of the invention, recipient R1 may be given permission to set or edit the rights of other recipients R2 and R3. Moreover, recipient RI may even optionally be given permission to invite other recipients to the shared communication channel (whether or not such additional individuals even are sent physical invitations 20).

In these various embodiments of the present system, the senders S may also post and share digital media with the various recipients R1, R2 and R3. All of these individuals preferably view the shared digital media through their smartphones 50. However, it is also contemplated that these individuals can access the shared communication channel through other computer devices (their laptops, desktops, etc.).

In optional aspects of the invention, the senders S can pre-authorize each of the recipients R1, R2 and R3 to join the augmented reality communication channel by pre-authorizing the smart device IDs of the other users to join the augmented reality communication channel. For example, senders S can pre-authorize the smart device phone numbers for each of recipients' R1, R2 and R3's phones 50. In this optional aspect of the invention, the smart device phone numbers are transmitted back to platform 10 when each recipient scans their invitation card 20. If the phone number matches one of the pre-authorized phone numbers, then augmented reality platform 10 permits that particular recipient's smart phone 50 to display the pre-recorded video. Alternatively, if the phone number does not match one of the pre-authorized phone numbers, augmented reality platform 10 does not permit that recipient to view the video or access the shared communication channel.

In optional aspects of the present system, greeting cards 20 are sent by mail. However, it is to be understood that they can instead be delivered by currier, hand delivered, or presented to the recipients by any format whatsoever. For example, they may be found as part of a game, or otherwise left for the recipients to find.

The above discussed examples refer to greeting card invitations or to business cards. It is to be understood that the present system of physical invitations, and can be used with (i) a greeting card or business card, (ii) a product or service brochure, or (iii) a sign or billboard. Other possible types of physical invitations are also contemplated within the scope of the present invention.

The above discussed examples referred to a QR Code as one preferred visual indicia on the physical card 20. It is to be understood that any form of visual indicia that can recognized by the camera on the recipient's smartphone 50 operating in conjunction with computer platform 10 is covered. For example, a QR Code may be omitted in those cases where computer platform 10 can recognize other features in the visual indicia of card 20. This includes, but is not limited to, image recognition software, optical character recognition systems, etc.

Pre-authorizing only certain phone numbers to open and play the videos has many security advantages. For example, different videos may be sent to different recipients (with the identities of the recipients corresponding to their phone numbers). For example, the senders S in FIG. 4A can send sent a first video to their friend R1 saying “Please come to our wedding”, while simultaneously sending a different video to one of their grandparents R2 saying “Grandma—we really hope you can make it to the wedding”. In this situation, the image (and optional QR Code) can be identical on both cards 20 sent to recipients R1 and R2. However, the different phone numbers of recipients R1 and R2 can be used by augmented reality platform 10 to distinguish which video is to be sent to which recipient.

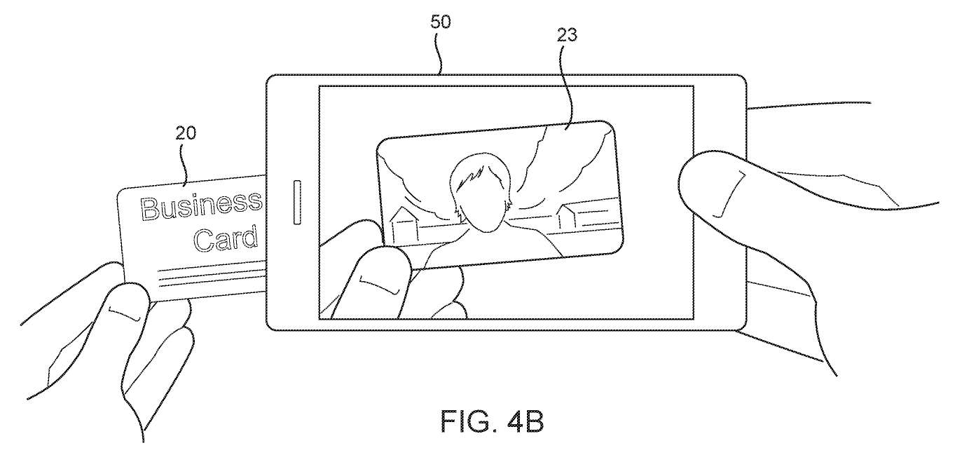

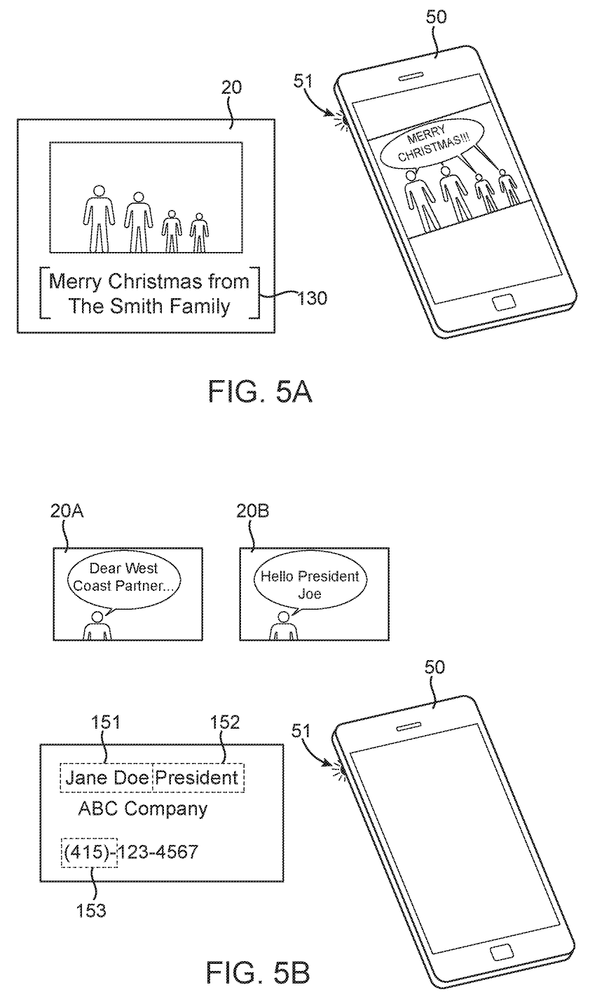

FIG. 5A is an illustration of an invitation being read by an Optical Character Recognition (OCR) scanner, as follows. Card 20 does not have a QR Code printed on its face. Rather, the app on smartphone 50 uses Optical Character Recognition (OCR) to read text 130 which says in this example “Merry Christmas From The Smith Family”. Next, platform 10 compares this text to text pre-stored in its database from various families that have made their Holiday Cards. As soon as the system positively identifies the video in its system stored as “Merry Christmas From The Smith Family”, it then proceeds to play the video on the screen of smartphone 50. The advantage of this OCR embodiment of the present system is that it avoids the use of a visually unappealing QR Code (which takes up space on the front of card 20).

FIG. 5B is an illustration of an Optical Character Recognition (OCR) system for pre-identifying an invitation recipient to determine which private video the invitation recipient will be viewing. In this aspect of the present system, the identity of the recipient can be used to play particular private videos for the recipient. For example, the recipient has just received card 20 but is first asked for his/her business card 150. The present Optical Character Recognition (OCR) system scans business card 150 and determines the owner's name 151, title 152 and phone number 153. In various aspects, the identity of either one (or any combination of) fields 151, 152 and 153 can be used to assign a particular private video to the recipient when (s)he scans card 20. For example, the card may recognize a west coast area code “415” and play a video pre-assigned for West Cost individuals (e.g.: card 20A which plays a video that starts out saying: “Dear West Coast Partner . . . ”). Alternately, the present system may recognize the title “President” and play a video pre-assigned for executive partners (e.g.: card 20B which plays a video that starts out saying: “As the leader of one of our corporate partners . . . ).

Thus, it is to be understood that the present use of Optical Character Recognition (OCR) can be to identify the invitation card, or to identify the recipient of the invitation card, or both. The advantage of using Optical Character Recognition (OCR) to identify the card is to make the full surface of the card visually appealing. The advantage of using Optical Character Recognition (OCR) to identify the recipient (i.e.: by identifying their particulars 151, 152 and 153) is that this person can then be added to the sender's contacts easily; or this person can be grouped together with other similar recipients such that particular private videos can be sent to particular groups of people. In these aspects of the present system, the object used to display the augmented reality video can be the sender's business card. The advantage of this is that the sender's business card can come alive and deliver a different message to different recipients. Thus, the sender may send their business cards with messages that are tailored to the recipient, or to the recipient's line of business, or to the location where the recipient lives/works, etc.

In preferred aspects, the present system requires the user (recipient) to tap onto the screen of their smartphone to simultaneously initialize an image based recognition system and an Optical Character Recognition (OCR) system. This combined use of image analysis and optical character recognition can be used to securely identify the invitation card. For example, the image based recognition system may recognize the card as using one of a preferred number of templates (such as a Wedding Invitation template), while the Optical Character Recognition (OCR) system reads the card which may state “Come to Eric And Anna's Wedding”. The simultaneous use of both an image recognition system and an Optical Character Recognition (OCR) system can advantageously recognize cards faster and with an additional layer of security (such that the present system does not play an incorrect augmented reality video).

Furthermore, the physical act of the recipient tapping on their smartphone's screen to simultaneously commence image and optical character recognition provides an easy to use starting point for both these systems to initialize. Specifically, the recipient's smartphone will be facing the card and ready to read the card when the smartphone's screen is tapped.

It is to be understood that the examples of FIGS. 5A and 5B are not limited to business cards. Rather, any printed material that has optically readable material can be used. For example, box labels, mailing labels, envelopes, signs, billboards, labels, etc. can also be used.

What is claimed is:

1. A method of operating a shared augmented reality communication channel on an augmented reality platform, comprising:
(a) a first user creating an augmented reality communication channel on the augmented reality platform;
(b) the first user creating a video and linking the video to the augmented reality communication channel on the augmented reality platform;
(c) the first user designing a physical invitation with visual indicia thereon and linking the visual indicia on the physical invitation to the augmented reality communication channel;
(d) the first user inviting one or more other users to join the augmented reality communication channel by sending the physical invitation to each of the other users;
(e) the other users each scanning the visual indicia on the physical invitation with a smart device such that:
(i) a display on the smart device displays the video in an augmented reality presentation superimposed on the physical invitation, and
(ii) access to the augmented reality communication channel is granted to the other users; and then
(f) the other users and the first user each sharing digital media with one another through the augmented reality communication channel.

2. The method of claim 1, further comprising:
(g) the first user pre-authorizing the other users to join the augmented reality communication channel by pre-authorizing the smart device IDs of the other users to join the augmented reality communication channel.

3. The method of claim 2, wherein the smart device IDs correspond to smart device phone numbers.

4. The method of claim 2, further comprising:
(h) the smart devices of each of the other users sending their smart device IDs to the augmented reality platform prior to each of the other users being granted access to the augmented reality communication channel.

5. The method of claim 1, wherein the shared digital media is stored in the smart devices of the other users after access has been granted to the augmented reality communication channel.

6. The method of claim 1, wherein the first user creates different videos for each of the other users, and the videos are played after the smart devices of the other users are recognized by the augmented reality platform such that each of the different users see different videos.

7. The method of claim 1, wherein the first user grants different sharing rights to different other users when setting up the shared augmented reality communication channel on the augmented reality platform.

8. The method of claim 1, further comprising:
(g) the first user granting rights to the other users to invite additional users into the shared augmented reality communication channel.

9. The method of claim 1, wherein the physical invitation comprises at least one of:
(i) a greeting card or a business card,
(ii) a product or a service brochure, or
(iii) a sign or a billboard.

10. The method of claim 1, wherein the identity of the physical invitation is determined by optical character recognition.

11. The method of claim 1, wherein the identity of the recipient of the physical invitation is determined by optical character recognition.

12. An augmented reality communication platform, comprising:
(a) a configuration system for users to define augmented reality communication channels;
(b) a physical invitation design system for users to design physical invitations having visual indicia thereon and associate the visual indicia on the physical invitations with the defined augmented reality communication channels;
(c) a video uploading system for users to upload videos and associate the uploaded videos with the defined augmented reality communication channels; and
(d) a communication system for users to communicate with one another over each of the defined augmented reality communication channels.

13. The augmented reality communication platform of claim 12, further comprising:
(e) a plurality of smart devices configured to:
(i) detect the visual indicia on the physical invitations,
(ii) display the uploaded videos superimposed on the physical invitations, and
(iii) share digital media among one another over the defined augmented reality communication channels.

14. The augmented reality communication platform of claim 12, further comprising:
(e) an authorization system for:
(i) users to pre-authorize the other users to join the augmented reality communication channels by pre-authorizing the smart device IDs of the other users to join the augmented reality communication channel, and
(ii) receiving the smart device IDs of the other users to permit authorization for the other users to join the augmented reality communication channels.

15. The augmented reality communication platform of claim 12, wherein the smart device IDs correspond to smart device phone numbers.

16. The augmented reality communication platform of claim 12, wherein the visual indicia on the physical invitations are machine recognizable features in an image on the physical invitations.

17. A method of operating an augmented reality computer platform to send a private augmented reality video to a recipient, comprising:
(a) a first user creating a private video;
(b) the first user designing a physical invitation with visual indicia thereon;
(c) the augmented reality computer platform associating the visual indicia on the physical invitation with the private video;
(d) the first user sending the physical invitation to a second user;
(e) the second user scanning the visual indicia on the physical invitation with a smart device;
(f) the smart device sending a smart device ID to an authorization system; and
(g) the authorization system permitting the second user to view the private video in an augmented reality presentation superimposed on the physical invitation.

18. The method of claim 17, wherein the smart device ID corresponds to the second user's smart device phone number.

19. The method of claim 17, further comprising:
(f) the first user creating a second private video,
(g) the first user designing a second physical invitation with visual indicia thereon;
(h) the first user associating the visual indicia on the second physical invitation with the second private video;
(i) the first user sending the second physical invitation to a third user;
(j) the third user scanning the visual indicia on the physical invitation with a smart device;
(k) the smart device sending a smart device ID to the authorization system;
(l) the authorization system permitting the third user to view the private video in an augmented reality presentation superimposed on the physical invitation.

20. The method of claim 19, wherein the second video is different from the first video such that the second and third users see different videos superimposed on the physical invitations.

21. The method of claim 19, further comprising:
(m) the first, second and third users sharing digital media over a shared augmented reality communication channel.

22. The method of claim 19, wherein the identity of the physical invitation is determined by optical character recognition.

23. The method of claim 19, wherein the identity of the recipient of the physical invitation is determined by optical character recognition.

24. An augmented reality computer platform, comprising:
(a) a physical invitation design system for a user to design a physical invitation having visual indicia thereon and associate the visual indicia on the physical invitations with a pre-defined recipient;
(b) a video uploading system for the user to upload private videos and associate the uploaded private videos with the pre-defined recipient; and
(c) an authorization system for:
(i) receiving a smart device ID from a second user after the second user's smart device has scanned the visual indicia on the physical invitation, and
(ii) permitting the second user to view the private video in an augmented reality presentation superimposed on the physical invitation.

25. The augmented reality communication platform of claim 24, wherein the smart device ID corresponds to the smart device phone number.

26. The augmented reality communication platform of claim 24, wherein the second user scans the visual indicia with an app resident on the smart device of the second user.

27. The augmented reality communication platform of claim 24, wherein user uses the authorization system to assign different private videos to different additional users.
